(19) United States
(12) Patent Application Publication
(10) Pub. No.: US 2025/0297148 A1
(43) Pub. Date: Sep. 25, 2025

(54) URETHANE ADHESIVE COMPOSITION FOR EASY SEPARATION FOR RECYCLE

(71) Applicants: Hyundai Motor Company, Seoul (KR); Kia Corporation, Seoul (KR); NOROO R&C Co, Ltd., Anyang (KR)

(72) Inventors: Sung Chul Shin, Incheon (KR); Jeong Su Bae, Chungcheongbuk-Ro (KR)

(21) Appl. No.: 18/825,118

(22) Filed: Sep. 5, 2024

(30) Foreign Application Priority Data
Mar. 19, 2024 (KR) 10-2024-0037508

(51) Int. Cl. C09J 175/04; C08J 9/00; C08J 9/32; C08K 3/04

(52) U.S. Cl. CPC C09J 175/04; C08J 9/0066; C08J 9/32; C08K 3/04; C08J 2203/22; C08J 2207/02; C08J 2375/04; C08K 2201/005; C08K 2201/019

(57) ABSTRACT

A urethane adhesive composition comprising a main material that includes a polyol, an inorganic blowing agent, and carbon black, and a curing material. The composition is designed to facilitate easy separation of adherends by applying a heat source, which activates the inorganic blowing agent and reduces the adhesive strength, enabling efficient recycling and compliance with environmental regulations.

### CROSS-REFERENCE TO RELATED APPLICATION

This application claims, under 35 U.S.C. § 119(a), the benefit of Korean Patent Application No. 10-2024-0037508, filed on Mar. 19, 2024, the entire contents of which are incorporated herein by reference.

### BACKGROUND

### (a) Technical Field

The present disclosure relates to a urethane adhesive composition for easy separation. This composition allows for the straightforward disassembly of products utilizing the adhesive, making them more suitable for recycling purposes.

### (b) Background Art

As industrial advancements and improvements in living standards continue, the generation of various types of waste is rapidly increasing. This trend has heightened interest in waste management methods, particularly those dealing with vehicle waste. In general, when end-of-life vehicles are delivered to junkyards, recyclable parts, liquids such as fuel and oil that are hazardous during dismantling, tires, and the like are recovered therefrom. Then, the parts recovered from end-of-life vehicles are recycled.

However, in the process of separating recyclable parts from end-of-life vehicles, each part is strongly attached to a vehicle body with an adhesive, making separation challenging.

Therefore, for recycling, there is a need to develop an adhesive in which sufficient adhesive strength is exhibited when used but adhesive strength is quickly decreased by external stimulation when necessary.

### SUMMARY OF THE DISCLOSURE

An object of the present disclosure is to provide a urethane adhesive composition that has high adhesive strength under actual use conditions but lowered adhesive strength when heated in a short time for easy recycling of adherends.

The objects of the present disclosure are not limited to the foregoing. The objects of the present disclosure will be able to be clearly understood through the following description and to be realized by the means described in the claims and combinations thereof.

An aspect of the present disclosure provides a urethane adhesive composition, including a main component including a polyol, an inorganic blowing agent, and carbon black, and a curing material.

In aspects, materials of the main component, e.g. the polyol, inorganic blowing agent and carbon block, will be present in admixture prior to curing.

In one embodiment, the polyol may include any one selected from the group consisting of polyether polyol, polyester polyol, and combinations thereof.

In one embodiment, the polyether polyol may include any one selected from the group consisting of polypropylene glycol (PPG), poly(tetramethylene ether)glycol (PTMEG), polyethylene glycol (PEG), and combinations thereof.

In one embodiment, the polyester polyol may include any one selected from the group consisting of adipate, caprolactone, and combinations thereof.

In one embodiment, the inorganic blowing agent may include thermally expandable microcapsules. Suitably, the inorganic blowing agent does not contain carbon or carbon substitution.

In one embodiment, the inorganic blowing agent may have a maximum blowing temperature of 110° C. to 120° C.

In one embodiment, the carbon black may have an average particle diameter of 20 μm to 30 μm.

In one embodiment, the carbon black may have plasticizer oil absorption of 50 cc/100 g to 60 cc/100 g.

In one embodiment, the main component may include, based on a total of 100 wt % of the main material, 40 wt % to 50 wt % of the polyol, greater than 3 wt % to less than 15 wt % of the inorganic blowing agent, and greater than 0 wt % to less than 3 wt % of the carbon black.

The main material may include about 4 wt % to 14 wt % of the inorganic blowing agent.

the main material may include about 1 wt % to 2 wt % of the carbon black.

In one embodiment, the urethane adhesive composition may include the main material and the curing material in a mass ratio of 1:0.5 to 1:1.

In one embodiment, the main component may further include an additive, and the additive may include any one selected from the group consisting of a curing accelerator, a filler, a moisture absorbent, a bonding agent, and combinations thereof.

In one embodiment, the curing material may include a main curing agent and a curing additive, and the curing additive may include any one selected from the group consisting of a colorant, a filler, a moisture absorbent, a flow regulator, and combinations thereof.

In some embodiments, the urethane adhesive composition may be free from conductive carbon, or at least substantially free of conductive carbon, e.g. less than 3, 2, 1, 0.5 or 0.25 or 0.1 weight percent of the urethane adhesive composition will be conductive carbon.

In some embodiments, the urethane adhesive composition may be free from nanographene or at least substantially free of nanographene, e.g. less than 3, 2, 1, 0.5 or 0.25 or 0.1 weight percent of the urethane adhesive composition will be nanographene.

In some embodiments, the urethane adhesive composition may be free from an organic blowing agent or at least substantially free of an organic blowing agent, e.g. less than 3, 2, 1, 0.5 or 0.25 or 0.1 weight percent of the urethane adhesive composition will be an organic blowing agent

In some embodiments, the urethane adhesive composition may be free from hydrazide or at least substantially free of hydrazide, e.g. less than 3, 2, 1, 0.5 or 0.25 or 0.1 weight percent of the urethan adhesive composition will be hydrazide.

Another aspect of the present disclosure provides a method of separating a urethane adhesive composition including applying a heat source to the urethane adhesive composition described above.

Here, the heat source may be one selected from the group consisting of microwave, a dry oven, a high-frequency induction heater, and a laser.

### DETAILED DESCRIPTION

The above and other objects, features and advantages of the present disclosure will be more clearly understood from the following preferred embodiments taken in conjunction with the accompanying drawings. However, the present disclosure is not limited to the embodiments disclosed herein, and may be modified into different forms. These embodiments are provided to thoroughly explain the disclosure and to sufficiently transfer the spirit of the present disclosure to those skilled in the art.

Throughout the drawings, the same reference numerals will refer to the same or like elements. For the sake of clarity of the present disclosure, the dimensions of structures are depicted as being larger than the actual sizes thereof. It will be understood that, although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element. As used herein, the singular forms are intended to include the plural forms as well, unless the context clearly indicates otherwise.

It will be further understood that the terms “comprise”, “include”, “have”, etc., when used in this specification, specify the presence of stated features, integers, steps, operations, elements, components, or combinations thereof, but do not preclude the presence or addition of one or more other features, integers, steps, operations, elements, components, or combinations thereof. Also, it will be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

In the present specification, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

A urethane adhesive composition according to an aspect of the present disclosure may include a room-temperature curable two-component adhesive composition including a main material and a curing material.

The main material may include a polyol, an inorganic blowing agent, and carbon black.

The present disclosure is characterized by the inclusion of an inorganic blowing agent in the main material. Thia agent can reduce the adhesion of the adhesive through behaviors such as expansion, dissociation, etc. when exposed to external stimuli such as heat, electricity, etc. Also, carbon black is included in the main material to ensure that the urethane adhesive composition may quickly reach a temperature at which the inorganic blowing agent exhibits its expansion or dissociation behavior.

In one embodiment, the polyol may include any one selected from the group consisting of polyether polyol, polyester polyol, and combinations thereof.

The polyether polyol may include any one selected from the group consisting of polypropylene glycol (PPG), poly(tetramethylene ether)glycol (PTMEG), polyethylene glycol (PEG), and combinations thereof.

Also, the polyester polyol may include any one selected from the group consisting of adipate, caprolactone, and combinations thereof.

In addition thereto, the polyol used is not particularly limited so long as it can form polyurethane by reacting with an isocyanate group. However, it should be noted that the formation of a conductive peelable adhesive or thermoplastic adhesive as a result is excluded.

In one embodiment, the inorganic blowing agent may include thermally expandable microcapsules. The thermally expandable microcapsules may be configured such that a blowing agent such as liquid hydrocarbon is placed in a shell containing a thermoplastic resin. The thermally expandable microcapsules may be a heating expandable blowing agent in which the blowing agent inside vaporizes when heated, thereby increasing internal pressure and expanding volume accordingly.

The blowing agent may have an average particle size D50 of 10 μm to 50 μm. When the average particle size D50 of the inorganic blowing agent falls within the above range, the separation strength upon heating may be sufficiently lowered without comprising the adhesion properties of the urethane adhesive composition.

In one embodiment, the inorganic blowing agent may have an expansion start temperature of 85° C. to 95° C. and a maximum blowing temperature of 110° C. to 120° C. The expansion start temperature may be a temperature at which the inorganic blowing agent begins to expand, and the maximum blowing temperature may be a temperature at which the inorganic blowing agent expands to a maximum volume.

If the maximum blowing temperature of the inorganic blowing agent is less than 110° C., separation strength of the urethane adhesive composition may not be sufficiently lowered because the inorganic blowing agent expands to a maximum volume before softening of the urethane adhesive composition. On the other hand, if the maximum blowing temperature of the inorganic blowing agent exceeds 120° C., the inorganic blowing agent may not expand even when heated, so there may be no effect of lowering separation strength of the urethane adhesive composition.

The carbon black serves as a thermal conductivity promoter, aiding the inorganic blowing agent in the urethane adhesive composition quickly reach the temperature at which it exhibits expansion or dissociation behavior. Here, the carbon black is not particularly limited so long as it refers to a fine carbon powder produced by thermal decomposition or incomplete combustion of carbon compounds or hydrocarbons, and examples thereof may include carbon black, furnace black, acetylene black, Ketjen black, and the like. However, the carbon black may not include epoxy, as this could increase separation strength due to reactions at high temperatures.

In one embodiment, the carbon black may have an average particle diameter of 20 μm to 30 μm. If the average particle diameter of the carbon black is less than 20 μm, plasticizer oil absorption may increase and viscosity of the urethane adhesive composition may increase. On the other hand, if the average particle diameter of the carbon black exceeds 30 μm, voids between particles may increase and thermal conductivity may decrease.

Also, the carbon black may have plasticizer oil absorption of 50 cc/100 g to 60 cc/100 g. Here, plasticizer oil absorption may be a value measured using a plasticizer oil absorption meter. For example, plasticizer oil absorption may be determined by placing a sample in a meter, adding a plasticizer dropwise with kneading, measuring the amount of added plasticizer when the torque during kneading increases and decreases to 70% of the maximum torque, and dividing the measured amount by the weight of the sample.

If the plasticizer oil absorption of carbon black is less than 50 cc/100 g, the viscosity of the urethane adhesive composition may decrease, hardness may increase, and elongation may decrease. On the other hand, if the plasticizer oil absorption exceeds 60 cc/100 g, viscosity of the urethane adhesive composition may increase, hardness may decrease, and adhesive strength at room temperature may decrease.

In one embodiment, the main material may include 40 wt % to 50 wt % of the polyol, greater than 3 wt % to less than 15 wt % of the inorganic blowing agent, and greater than 0 wt % to less than 3 wt % of the carbon black. When the amounts of the polyol, inorganic blowing agent, and carbon black fall within the above ranges, separation strength when heated may be sufficiently lowered without decreasing adhesive strength at room temperature.

In one embodiment, the polyol may include polyether polyol and polyester polyol. Here, the main material may include 20 wt % to 25 wt % of the polyether polyol and 20 wt % to 25 wt % of the polyester polyol.

If the amount of polyether polyol is less than 20 wt %, elongation of the urethane adhesive composition may decrease. On the other hand, if the amount of polyether polyol exceeds 25 wt %, adhesive strength at room temperature of the urethane adhesive composition may decrease. In addition, if the amount of polyester polyol is less than 20 wt %, adhesive strength at room temperature of the urethane adhesive composition may decrease. On the other hand, if the amount of polyester polyol exceeds 25 wt %, elongation of the urethane adhesive composition may decrease.

If the amount of the inorganic blowing agent is 3 wt % or less, separation strength may not be sufficiently lowered even when the urethane adhesive composition is irradiated by a heat source. On the other hand, if the amount of the inorganic blowing agent is 15 wt % or more, room-temperature strength of the urethane adhesive composition may decrease. Preferably, the main material includes 4 wt % to 14 wt % of the inorganic blowing agent.

If the main material does not include carbon black, the separation strength may not be sufficiently lowered even when the urethane adhesive composition is exposed to a heat source. On the other hand, if the amount of carbon black is 3 wt % or more, adherends may be contaminated. Preferably, the main material includes 1 wt % to 2 wt % of the carbon black.

Additionally, the main material may further include an additive such as a curing accelerator, a filler, a moisture absorbent, a bonding agent, etc.

The type of curing accelerator is not particularly limited. Examples of the curing accelerator may include tertiary amines such as DMP-30 and/or 1,5-diazabicyclo[4.3.0]non-5-ene.

When using a tertiary amine as the curing accelerator, the main material may include 1 wt % to 3 wt % of the curing accelerator. If the amount of the curing accelerator is less than 1 wt %, the curing speed of the urethane adhesive composition may decrease. On the other hand, if the amount of the curing accelerator exceeds 3 wt %, storage stability of the urethane adhesive composition may deteriorate.

When using 1,5-diazabicyclo(4.3.0)non-5-ene as the curing accelerator, the main material may include 0.2 wt % to 0.5 wt % of the curing accelerator such as 1,5-diazabicyclo(4.3.0)non-5-ene. If the amount of the curing accelerator is less than 0.2 wt %, the curing speed of the urethane adhesive composition may decrease. On the other hand, if the amount of the curing accelerator exceeds 0.5 wt %, working life (pot life) may be excessively reduced.

The type of filler is not particularly limited. An example of the filler may include calcium carbonate (CaCO₃). The main material may include 30 wt % to 40 wt % of the filler. If the amount of the filler is less than 30 wt %, flowability of the urethane adhesive composition may be reduced. On the other hand, if the amount of the filler exceeds 40 wt %, it may be difficult to achieve specific gravity requirements of the urethane adhesive composition.

The type of moisture absorbent is not particularly limited. An example of the moisture absorbent may include zeolite. The main material may include 5 wt % to 7 wt % of the moisture absorbent. If the amount of the moisture absorbent is less than 5 wt %, bubbles may form inside the urethane adhesive composition and adhesive strength at room temperature may decrease. On the other hand, if the amount of the moisture absorbent exceeds 7 wt %, storage stability may deteriorate.

The type of bonding agent is not particularly limited. An example of the bonding agent may include a modified vinyl bonding agent. The main material may include 1 wt % to 2 wt % of the bonding agent. If the amount of the bonding agent is less than 1 wt %, adhesive strength at room temperature may decrease, whereas if the amount of the bonding agent exceeds 2 wt %, the curing speed may decrease.

In one embodiment, the curing material may include a main curing agent and a curing additive. The curing additive may include a colorant, a filler, a moisture absorbent, a flow regulator, etc.

The type of main curing agent is not particularly limited. An example of the main curing agent may include methylene diphenyl diisocyanate (MDI) prepolymer. The curing material may include 75 wt % to 85 wt % of the main curing agent. If the amount of the main curing agent is less than 75 wt %, the curing time of the urethane adhesive composition may be delayed and adhesive strength at room temperature may decrease. On the other hand, if the amount of the main curing agent exceeds 85 wt %, pot life may be excessively reduced.

The type of colorant is not particularly limited. An example of the colorant may include carbon black. The curing material may include 0.2 wt % to 0.5 wt % of the colorant. If the amount of the colorant is less than 0.2 wt %, it may be difficult to achieve a desired color. On the other hand, if the amount of the colorant exceeds 0.5 wt %, viscosity of the urethane adhesive composition may increase and elongation may decrease.

The type of filler is not particularly limited. An example of the filler may include calcium carbonate (CaCO₃). The curing material may include 7 wt % to 12 wt % of the filler. If the amount of the filler is less than 7 wt %, flowability of the urethane adhesive composition may be reduced. On the other hand, if the amount of the filler exceeds 12 wt %, it may be difficult to achieve the desired viscosity requirements of the urethane adhesive composition.

The type of moisture absorbent is not particularly limited. An example of the moisture absorbent may include zeolite. The curing material may include 3 wt % to 5 wt % of the moisture absorbent. If the amount of the moisture absorbent is less than 3 wt %, bubbles may form inside the urethane adhesive composition and adhesive strength at room temperature may decrease. On the other hand, if the amount of the moisture absorbent exceeds 5 wt %, storage stability may deteriorate.

The type of flow regulator is not particularly limited. An example of the flow regulator may include fumed silica. The curing material may include 1 wt % to 3 wt % of the flow regulator. If the amount of the flow regulator is less than 1 wt %, flowability of the urethane adhesive composition may be reduced. On the other hand, if the amount of the flow regulator exceeds 3 wt %, it may be difficult to achieve viscosity requirements of the urethane adhesive composition.

In one embodiment, the urethane adhesive composition may include the main material and the curing material in a mass ratio of 1:0.5 to 1:1. When the mass ratio of the main material to the curing material falls within this range, the urethane adhesive composition may be cured at an appropriate temperature and may exhibit excellent adhesive strength.

The urethane adhesive composition according to the present disclosure is capable of bonding a variety of substrates, including wood, metal, coated metal, aluminum, various plastic and filled plastic substrates, fiberglass, and the like. In a preferred embodiment, the urethane adhesive composition is used to bond vehicle parts or to bond the vehicle parts to a vehicle body. Examples of the vehicle parts may include steel, coated steel, galvanized steel, aluminum, coated aluminum, plastic and filled plastic substrates.

Since the urethane adhesive composition according to the present disclosure has excellent aging resistance at a high temperature of about 100° C., it may maintain high adhesive strength without separation under actual use conditions.

In addition, a method of separating the urethane adhesive composition according to the present disclosure may include applying a heat source to the urethane adhesive composition. The type of heat source is not particularly limited and may be, for example, a microwave, a dry oven, a high-frequency induction heater, lasers, etc., preferably a microwave. A microwave, which can reach a high temperature in a short time, may have a low possibility of material deformation and may be used on relatively large parts.

The urethane adhesive composition according to the present disclosure has separation strength of 2.0 MPa or less, 0.5 MPa or less, 0.2 MPa or less, or 0 MPa when heated, and thus when irradiated with microwaves, the adherend attached by the urethane adhesive composition may be easily disassembled and separated and thus recycled. Moreover, since the urethane adhesive composition according to the present disclosure has adhesive strength at room temperature of 17 MPa or more, it may provide appropriate adhesion when using an article to which the adhesive composition is applied.

A better understanding of the present disclosure may be obtained through the following examples and comparative examples. These examples are not to be construed as limiting the scope of the present disclosure.

### Test Example 1

In order to determine the optimal compositions for a separation strength lowering material and a thermal conductivity promoter added to a room-temperature curable two-component urethane adhesive composition, a main material and a curing material were prepared as shown in Table 1 below. In this context, the main material according to Table 1 below is configured to include only either the separation strength lowering material or the thermal conductivity promoter. For reference, the amount of polyol was appropriately adjusted so that the sum of the amounts of components in the main material was 100 wt %. Also, the amount of the main curing agent was appropriately adjusted so that the sum of the amounts of components in the curing material was 100 wt %.

TABLE 1

| Main material | | | | Curing material | | | |
|---|---|---|---|---|---|---|---|
| | | | Amount | | | | Amount |
| | Material | | (wt %) | | Material | | (wt %) |
| 1 | Polyol | Polypropylene glycol | 20-25 | 1 | Main | MDI | 75-85 |
| | | | | | curing | Prepolymer | |
| | | | | | agent | | |
| 2 | | Polyester | 20-25 | 2 | Colorant | Carbon | 0.2-0.5 |
| | | | | | | black | |
| 3 | Curing | Tertiary amine | 1-3 | 3 | Filler | CaCO₃ | 7-12 |
| 4 | accelerator | 1,5- | 0.2-0.5 | 4 | Moisture | Zeolite | 3-5 |
| | | Diazabicyclo[4.3.0]non-5-ene | | | absorbent | | |
| 5 | Filler | CaCO₃ | 30-40 | 5 | Flow | Fumed | 1-3 |
| | | | | | regulator | silica | |
| 6 | Moisture | Zeolite | 5-7 | | | | |
| | absorbent | | | | | | |
| 7 | Bonding | Modified vinyl | 1-2 | | | | |
| | agent | bonding agent | | | | | |
| 8 | Separation | Inorganic blowing | 3-15 | | | | |
| | strength | agent/organic | | | | | |
| | lowering | blowing agent/ | | | | | |
| | material | hydrazide | | | | | |
| 8 | Thermal | Epoxy-containing | 0-3 | | | | |
| | conductivity | conductive carbon/ | | | | | |
| | promoter | carbon black/ | | | | | |
| | | nanographene | | | | | |

| | | | | |
|---|---|---|---|---|
| — | Total | 100 | Total | 100 |

The inorganic blowing agent used was AkzoNobel 031 DU 40, the organic blowing agent used was one having hexamethylene tetramine as a main ingredient, and the hydrazide used was one having 4,4′-oxybis(benzenesulfonyl hydrazide) as a main ingredient. In addition, the epoxy-containing conductive carbon used was a mixture of 50 wt % epoxy and 50 wt % acetylene black with an average particle diameter of 35 nm. The carbon black used was Vulcan XC72 having an average particle diameter of 28 μm and plasticizer oil absorption of 55 cc/100 g. The nanographene used was one having an average particle diameter of 20 μm to 167 μm.

A urethane adhesive composition was prepared by mixing the main material and the curing material, having the compositions shown in Table 1, and adhesive strength at room temperature and separation strength of the urethane adhesive composition were measured by the following methods.

### 1) Adhesive Strength at Room Temperature

A urethane adhesive composition was applied at a width of 12.5 mm onto the end of the 100×25×0.8t painted steel (steel plate identically manufactured with vehicle body paint). The same painted steel plate was stacked on top, ensuring that only the area coated with the urethane adhesive was overlapped. The resulting stack was fixed with clamps and left at room temperature for 168 hours. After this period, the maximum load was determined by tension at a speed of 5 mm/min using a tensile tester. This maximum load was recorded as the adhesive strength at room temperature.

### 2) Separation Strength

After leaving at room temperature (RT) for 168 hours in the same manner as in the “Adhesive strength at room temperature” above, the stack was irradiated with 10A microwaves for 7 minutes and then left at room temperature for 1 hour, after which the maximum load was determined by tension at a speed of 5 mm/min using a tensile tester, and was set as separation strength.

The results thereof are shown in Table 2 below.

TABLE 2

| | | | | | Temperature of |
|---|---|---|---|---|---|
| | | | | | painted steel |
| | | | Adhesion (MPa) | | plate upon |
| | | Amount | Adhesive | Separation | application of |
| Classification | | (wt %) | strength at RT | strength | heat source |
| Existing adhesive | | — | 14.3 | 4.2 | — |
| Separation | Inorganic | 10% | 10.2 | 2.5 | 138° C. |
| strength | blowing agent | 15% | 8.0 | 0 | 138° C. |
| lowering | Organic | 5% | 6.9 | 4.0 | 130° C. |
| material | blowing agent | 10% | 7.2 | 0 | 130° C. |
| | Hydrazide | 5% | 9.9 | 9.2 | 120° C. |
| | | 10% | 9.5 | 7.8 | 120° C. |
| Thermal | Epoxy- | 3% | 12.2 | 12.5 | 160° C. |
| conductivity | containing | 5% | 10.6 | 11.3 | 160° C. |
| Promoter | conductive | | | | |
| | carbon | | | | |
| | Carbon black | 3% | 12.9 | 0 | 210° C. |
| | | 5% | 12.7 | 0 | 210° C. |
| | Nanographene | 0.2% | 11.3 | 12.5 | 150° C. |
| | | 1.0% | 12.5 | 13.8 | 150° C. |

As shown in Table 2, when the inorganic blowing agent was used as the separation strength lowering material, there was an effect of lowering separation strength due to blowing at a high temperature. The organic blowing agent had the effect of lowering separation strength, but the extent of decreasing adhesive strength at room temperature was great compared to the inorganic blowing agent. Even though a product known to blow at about 120° C. was used, it was confirmed that some blowing occurred from 90° C. Moreover, in the case of hydrazide, the molecular weight of urethane resin needs to be reduced by reacting carboxylic acid with urethane resin. However, in practice, separation strength increased due to reaction with unreacted isocyanate groups or —OH groups or self-reaction.

Thereby, the inorganic blowing agent was confirmed to be the most ideal as the separation strength lowering material.

As shown in Table 2, when carbon black was used as the thermal conductivity promoter, the effect of promoting thermal conductivity was excellent. In addition, when carbon black was added alone without any separation strength lowering material, low separation strength was achieved, but application thereof was difficult due to contamination of adherends. In the case of epoxy-containing conductive carbon, there was an effect of promoting thermal conductivity, but separation strength increased due to reaction of the epoxy contained in the conductive carbon at a high temperature. Additionally, in the case of nanographene, the separation strength was observed to increase due to the reaction of the hydroxyl group coating of the nanographene with the urethane.

Thereby, carbon black, which does not contain epoxy, was confirmed to be the most ideal as the thermal conductivity promoter.

### Test Example 2

In order to determine adhesive strength at room temperature and separation strength depending on the amounts of the inorganic blowing agent and the carbon black included in the main material, a main material and a curing material were prepared as shown in Table 3 below. Here, the main material according to Table 3 below is configured to include both a separation strength lowering material and a thermal conductivity promoter, unlike in Test Example 1. For reference, the amount of polyol was appropriately adjusted so that the sum of the amounts of components in the main material equated 100 wt %. Similarly, the amount of the main curing agent was appropriately adjusted so that the sum of the amounts of components in the curing material equated 100 wt %.

TABLE 3

| Main material | | | | Curing material | | | |
|---|---|---|---|---|---|---|---|
| | | | Amount | | | | Amount |
| | Material | | (wt %) | | Material | | (wt %) |
| 1 | Polyol | Polypropylene glycol | 20-25 | 1 | Main | MDI | 75-85 |
| | | | | | curing | Prepolymer | |
| | | | | | agent | | |
| 2 | | Polyester | 20-25 | 2 | Colorant | Carbon | 0.2-0.5 |
| | | | | | | black | |
| 3 | Curing | Tertiary amine | 1-3 | 3 | Filler | CaCO₃ | 7-12 |
| 4 | accelerator | 1,5- | 0.2-0.5 | 4 | Moisture | Zeolite | 3-5 |
| | | Diazabicyclo[4.3.0]non-5-ene | | | absorbent | | |
| 5 | Filler | CaCO₃ | 30-40 | 5 | Flow | Fumed | 1-3 |
| | | | | | regulator | silica | |
| 6 | Moisture | Zeolite | 5-7 | | | | |
| | absorbent | | | | | | |
| 7 | Bonding | Modified vinyl | 1-2 | | | | |
| | agent | bonding agent | | | | | |
| 8 | Separation | Inorganic blowing | 3-15 | | | | |
| | strength | agent | | | | | |
| | lowering | | | | | | |
| | material | | | | | | |
| 9 | Thermal | Carbon black | 0-3 | | | | |
| | conductivity | | | | | | |
| | promoter | | | | | | |

| | | | | |
|---|---|---|---|---|
| — | Total | 100 | Total | 100 |

A urethane adhesive composition was prepared by mixing the main material and the curing material, having the compositions shown in Table 3, and then adhesive strength at room temperature (RT) and separation strength of the urethane adhesive composition were measured. The results are shown in Table 4 below. The individual compositions for the main material and the curing material are substantially the same as those described in Test Example 1; therefore, redundant descriptions are omitted.

TABLE 4

| | | Adhesion (MPa) | | Temperature of |
|---|---|---|---|---|
| | | Adhesive | | painted steel plate |
| | | strength | Separation | upon application of |
| Classification | | at RT | strength | heat source |
| Existing adhesive | | 14.3 | 4.2 | — |
| Inorganic | Carbon black | 13.5 | 4.7 | 138° C. |
| blowing | (0 wt %) | | | |
| agent | Carbon black | 13.1 | 0.5 | 168° C. |
| (3 wt %) | (1 wt %) | | | |
| | Carbon black | 12.8 | 0.3 | 198° C. |
| | (2 wt %) | | | |
| | Carbon black | 12.7 | 0.3 | 210° C. |
| | (3 wt %) | | | |
| Inorganic | Carbon black | 12.0 | 3.6 | 168° C. |
| blowing | (0 wt %) | | | |
| agent | Carbon black | 11.9 | 0 | 176° C. |
| (5 wt %) | (1 wt %) | | | |
| | Carbon black | 12.6 | 0 | 188° C. |
| | (2 wt %) | | | |
| | Carbon black | 11.3 | 0 | 210° C. |
| | (3 wt %) | | | |
| Inorganic | Carbon black | 10.2 | 2.5 | 138° C. |
| blowing | (0 wt %) | | | |
| agent | Carbon black | 10.9 | 0 | 193° C. |
| (10 wt %) | (1 wt %) | | | |
| | Carbon black | 10.5 | 0 | 200° C. |
| | (2 wt %) | | | |
| | Carbon black | 9.8 | 0 | 220° C. |
| | (3 wt %) | | | |
| Inorganic | Carbon black | 8.0 | 0 | 138° C. |
| blowing | (0 wt %) | | | |
| agent | Carbon black | 7.6 | 0 | 210° C. |
| (15 wt %) | (1 wt %) | | | |
| | Carbon black | 7.8 | 0 | 210° C. |
| | (2 wt %) | | | |
| | Carbon black | 6.3 | 0 | 218° C. |
| | (3 wt %) | | | |

As shown in Table 4, when the amount of the inorganic blowing agent in the main material was 3 wt %, separation strength increased compared to existing adhesive. Also, when the amount of the inorganic blowing agent in the main material was 15 wt %, adhesive strength at room temperature was excessively low. Furthermore, when the amount of the inorganic blowing agent was 5 wt % or 10 wt %, both adhesive strength at room temperature and separation strength were improved in a balanced manner.

Meanwhile, when the amount of carbon black in the main material was 1 wt % or 2 wt %, the effect of promoting thermal conductivity was adequate and there was no contamination of adherends.

### Test Example 3

In order to confirm other properties of the urethane adhesive composition according to the present disclosure, the urethane adhesive composition including 5 wt % of an inorganic blowing agent and 2 wt % of carbon black in a main material was measured as to tensile strength, elongation, and shear strength in various states by the following methods. The results thereof are given in Table 5 below.

### 1) Tensile Strength and Elongation

Measurement was performed according to KS M ISO527-2 (tensile properties of plastic). Here, the thickness of a specimen was 2 mm to 3 mm, and the tensile speed was evaluated at 5 mm/min.

### 2) Shear Strength

The urethane adhesive composition was applied at a width of 12.5 mm onto the end of 100×25×0.8t painted steel (steel plate identically manufactured with vehicle body paint). The same painted steel plate was stacked on top, ensuring that only the area coated with the urethane adhesive was overlapped. The resulting stack was fixed with clamps and left under the following conditions, after which the maximum load was determined by tension at a speed of 5 mm/min using a tensile tester, and was set as adhesive strength at room temperature.
Standard state: leaving at room temperature for 168 hours
Water resistance: leaving at room temperature for 72 hours->immersion in water at 40° C. for 336 hours->leaving at room temperature for 1 hour
Heat aging: leaving at room temperature for 72 hours->heating at 90° C. for 336 hours->leaving at room temperature for 1 hour
Heat cycle: leaving at room temperature for 72 hours->10 cycles->leaving at room temperature for 1 hour
* 1 cycle: heating at 90° C. for 3 hours->leaving at room temperature for 1 hour->leaving at −30° C. for 3 hours->leaving at room temperature for 1 hour->heating at 50° C. and 95% relative humidity for 15 hours->leaving at room temperature for 1 hour
Separation strength: leaving at room temperature for 168 hours->application of 10A microwaves for 7 minutes->leaving at room temperature for 1 hour
100° C. aging: leaving at room temperature for 72 hours->heating to 100° C. for 1 hour->leaving at room temperature for 1 hour

TABLE 5

| | | | | Test |
|---|---|---|---|---|
| Test items | | | Requirements | results |
| Curing | Tensile strength | | 8 or more | 9.3 |
| properties | Elongation | | 50% or more | 98 |
| | Shear | Standard state | 10 MPa or more | 13.6 |
| | strength | Water resistance | 10 MPa or more | 12.9 |
| | | Heat aging | 10 MPa or more | 13.0 |
| | | Heat cycle | 10 MPa or more | 12.4 |
| | | Separation | 0.2 MPa or less | 0 |
| | | strength | | |
| | | 100° C. aging | Degradation rate | 0.7% |
| | | | of 10% or less | |
| | | | compared to standard | |

As is apparent from the above description, a urethane adhesive composition according to the present disclosure includes an inorganic blowing agent that expands in volume due to external stimulation by a heat source and carbon black that improves thermal conductivity. This results in high adhesive strength under actual use conditions, but the adhesive strength can decrease when heated in a short time.

The use of the urethane adhesive composition according to the present disclosure enables easy recycling of adherends, thereby complying with environmental regulations, contributing to a carbon-neutral society, and reducing recycling and/or reuse costs.

The effects of the present disclosure are not limited to the above-mentioned effects. It should be understood that the effects of the present disclosure include all effects that can be inferred from the description of the present disclosure.

As the embodiments of the present disclosure have been described above, those skilled in the art will appreciate that various modifications and alterations are possible through change, deletion or addition of components without departing from the scope and spirit of the present disclosure as described in the accompanying claims, which will also be said to be included within the scope of rights of the present disclosure.

What is claimed is:

1. A urethane adhesive composition, comprising:
a main component comprising a polyol, an inorganic blowing agent, and carbon black; and
a curing material.

2. The urethane adhesive composition of claim 1, wherein the polyol comprises any one selected from the group consisting of polyether polyol, polyester polyol, and combination thereof.

3. The urethane adhesive composition of claim 2, wherein the polyether polyol comprises any one selected from the group consisting of polypropylene glycol (PPG), poly(tetramethylene ether)glycol (PTMEG), polyethylene glycol (PEG), and combinations thereof.

4. The urethane adhesive composition of claim 2, wherein the polyester polyol comprises any one selected from the group consisting of adipate, caprolactone, and combination thereof.

5. The urethane adhesive composition of claim 1, wherein the inorganic blowing agent comprises thermally expandable microcapsules.

6. The urethane adhesive composition of claim 1, wherein the inorganic blowing agent has a maximum blowing temperature of about 110° C. to 120° C.

7. The urethane adhesive composition of claim 1, wherein the carbon black has an average particle diameter of about 20 μm to 30 μm.

8. The urethane adhesive composition of claim 1, wherein the carbon black has a plasticizer oil absorption of about 50 cc/100 g to 60 cc/100 g.

9. The urethane adhesive composition of claim 1, wherein the main component comprises, based on a total of 100 wt % of the main component:
about 40 wt % to 50 wt % of the polyol,
greater than about 3 wt % to less than about 15 wt % of the inorganic blowing agent, and
greater than 0 wt % to less than about 3 wt % of the carbon black.

10. The urethane adhesive composition of claim 9, wherein the main component comprises about 4 wt % to 14 wt % of the inorganic blowing agent.

11. The urethane adhesive composition of claim 9, wherein the main component comprises about 1 wt % to 2 wt % of the carbon black.

12. The urethane adhesive composition of claim 1, wherein the urethane adhesive composition comprising the main component and the curing material in a mass ratio of about 1:0.5 to 1:1.

13. The urethane adhesive composition of claim 1, wherein the main component further comprises an additive, and the additive comprises any one selected from the group consisting of a curing accelerator, a filler, a moisture absorbent, a bonding agent, and combinations thereof.

14. The urethane adhesive composition of claim 1, wherein the curing material comprises a main curing agent and a curing additive, and wherein the curing additive comprises any one selected from the group consisting of a colorant, a filler, a moisture absorbent, a flow regulator, and combinations thereof.

15. The urethane adhesive composition of claim 1, wherein the urethane adhesive composition is free from epoxy-containing conductive carbon.

16. The urethane adhesive composition of claim 1, wherein the urethane adhesive composition is free from nanographene.

17. The urethane adhesive composition of claim 1, wherein the urethane adhesive composition is free from an organic blowing agent.

18. The urethane adhesive composition of claim 1, wherein the urethane adhesive composition is free from hydrazide.

19. A method of separating the urethane adhesive composition comprising applying a heat source to the urethane adhesive composition of claim 1.

20. The method of claim 19, wherein the heat source comprise one selected from the group consisting of microwave, a dry oven, a high-frequency induction heater, and a laser.
